(19) United States
(12) Patent Application Publication
(10) Pub. No.: US 2026/0110982 A1
(43) Pub. Date: Apr. 23, 2026

(54) IMAGE FORMING APPARATUS

(71) Applicant: CANON KABUSHIKI KAISHA, Tokyo (JP)

(72) Inventor: CHIAKI YOSHIWARA, Ibaraki (JP)

(21) Appl. No.: 19/324,667

(22) Filed: Sep. 10, 2025

(30) Foreign Application Priority Data
Oct. 21, 2024 (JP) 2024-184713

(51) Int. Cl. G03G 15/20

(52) U.S. Cl. CPC G03G 15/2046; G03G 15/2064

(57) ABSTRACT

An image forming apparatus including a control portion, wherein one mode can be performed among multiple modes including a first mode and a second mode in a mixed job in which multiple recording materials are mixed that include a first recording material with a first basis weight and a second recording material with a second basis weight that is less than the first basis weight, wherein when the first mode is set, the control portion performs such a control that a toner image is fixed to the recording material with the first basis weight and the recording material with the second basis weight at a common constant adjusted temperature on condition that the recording material with the first basis weight does not follow the recording material with the second basis weight, and wherein when the second mode is set, the control portion performs such a control that a toner image is fixed to the recording material with the first basis weight at a first temperature suitable for the first basis weight and a toner image is fixed to the recording material with the second basis weight at a second temperature suitable for the second basis weight.

### BACKGROUND

### Field of the Technology

This disclosure relates to an image reading apparatus for fixing a toner image onto a recording material such as a copy machine, a printer, a facsimile apparatus and a multifunctional machine with these multiple functions.

### Description of the Related Art

In an image forming apparatus using electrophotographic system or electrostatic recording system, a fixing device for fixing an unfixed toner image on a recording material to a recording material is provided.

The configuration of a fixing device is known as the one having a heating rotating member provided with a heating source for heating an unfixed toner image, a pressurizing roller that pressurizes the heating rotating member. The fixing device has an abutting and separating mechanism which can be moved between a position in which the pressurizing rotating member abuts to the heating rotating member and a position in which the pressurizing rotating member is separated from the heating rotating member. When the pressurizing rotating member is in the position where the pressurizing rotating member abuts to the heating rotating member, a nip portion is formed by the heating rotating member and the pressurizing rotating member. When a recording material on which an unfixed toner image is borne is conveyed to this nip portion, the heat and the pressure necessary for the fixation are applied so that the toner image is fixed to the recording material.

When a toner image is fixed onto a recording material, a heat amount deprived by the recording material becomes larger as the basis weight of the recording material is larger correspondingly to the types of the recording materials. Therefore, it is necessary to increase a fixing temperature of the fixing device as the basis weight of the recording material is larger. For this reason, a temperature adjusting control is performed in which the temperature of the heating rotating member is changed according to a type of the recording material. With this configuration, a heat amount provided to the the toner image on the recording material is properly controlled.

However, in the above configuration, when a fixing operation is successively performed for different types of recording materials, the continuous fixing operation has to be interrupted until the temperature of the heating rotating member has been actually changed to the most appropriately adjusted temperature corresponding to the type of the recording material every time types of recording materials are changed.

As described above, changing the temperature to the most appropriately adjusted temperature for every types of the recording materials when the fixing operation is continuously performed for different types of recording materials leads to an improvement of the quality of a toner image formed on the recording material. But at the same time, it may invite a decrease in productivity.

In view of this, Japanese Patent Laid-Open Application No. 2005-321478 discloses that a productivity-prioritized mode is provided separately from a fixing mode in which the temperature is changed to the most appropriately adjusted temperature for each type of the recording materials when a fixing operation is continuously performed for different types of recording materials. In the productivity-prioritized mode, a fixing operation is performed with a common constant adjusted temperature within allowable ranges for different types of the recording materials without changing the adjusted temperature for each type of the recording materials in order not to interrupt the continuous fixing operation.

### SUMMARY

One aspect of the present disclosure is an image forming apparatus comprising:
a heating rotating member configured to supply heat to a recording material;
a pressurizing rotating member configured to pressurize the heating rotating member;
a temperature control portion configured to control a temperature of the heating rotating member;
an acquiring portion configured to acquire information regarding a basis weight of the recording material to which the toner image is fixed; and
a control portion,
wherein a toner image is fixed on the recording material by being supplied with heat and pressure by the heating rotating member and the pressurizing rotating member,
wherein one mode can be performed among multiple modes including a first mode and a second mode in a mixed job in which multiple recording materials are mixed that include a first recording material with a first basis weight and a second recording material with a second basis weight that is less than the first basis weight,
wherein when the first mode is set, the control portion performs such a control that a toner image is fixed to the recording material with the first basis weight and the recording material with the second basis weight at a common constant adjusted temperature on condition that the recording material with the first basis weight does not follow the recording material with the second basis weight, and
wherein when the second mode is set, the control portion performs such a control that a toner image is fixed to the recording material with the first basis weight at a first temperature suitable for the first basis weight and a toner image is fixed to the recording material with the second basis weight at a second temperature suitable for the second basis weight.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing the configuration of an image processing system according to an embodiment of the present disclosure.

FIG. 2 is a diagram showing the system configuration of the image processing system illustrated in FIG. 1 according to the embodiment of the present disclosure.

FIG. 3 is a diagram showing the configuration of an image forming apparatus illustrated in FIG. 1 according to the embodiment of the present disclosure.

FIG. 4 is a diagram showing an enlarged cross section of a fixing device according to the embodiment of the present disclosure.

FIGS. 5A, 5B, 5C and 5D are explanatory diagrams showing a display for setting a book-prioritized temperature adjusting mode according to the embodiment of the present disclosure.

FIG. 6 is a table showing the relationship between types of media and adjusted temperatures for respective temperature adjusting modes according to the embodiment of the present disclosure.

FIGS. 7A and 7B are explanatory diagrams showing a fixing order of jobs with a cover sheet/inner sheet according to the embodiment of the present disclosure.

FIG. 8 is a flowchart of the CPU 222 illustrated in FIG. 2 according to the embodiment of the present disclosure.

### DESCRIPTION OF THE EMBODIMENTS

In the following, the embodiments of the present disclosure will be described with reference to the figures. The components in the following embodiments are just examples and the configuration, the function, and the various conditions such as dimensions, materials, shapes and relative positions of the apparatus to which the embodiment is applied can be modified or altered as appropriate without departing from the gist of the present disclosure, so that they are not limited to the following embodiments.

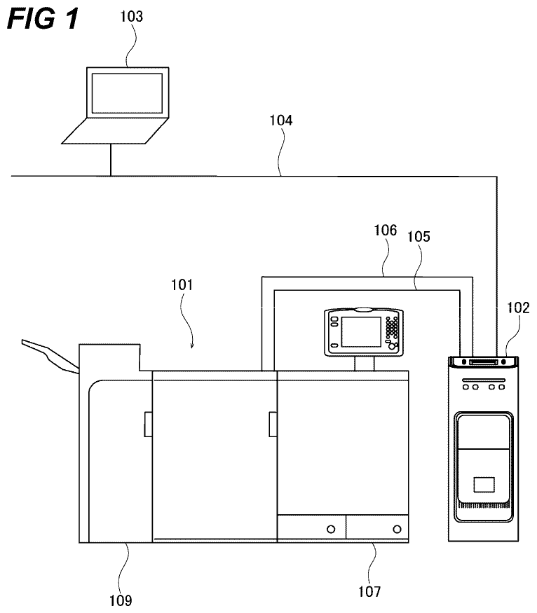

FIG. 1 is a diagram showing the configuration of an image processing system according to an embodiment of the present disclosure.

As shown in FIG. 1, the image processing system 1 is provided with the image forming apparatus 101 and the external controller 102. The image forming apparatus 101 is exemplified as, for example, a multifunctional apparatus, or a multifunctional peripheral (MFP). The external controller 102 is exemplified as, for example, an image processing controller, a digital front-end (DFE), or a printer server.

The image forming apparatus 101 and the external controller 102 are connected to communicate with each other via the internal Local Area Network (LAN) 105 and the video cable 106. The external controller 102 is connected to the client Personal Computer (PC) 103 via the external LAN 104. The external controller 102 obtains a print instruction (print job) from the client PC 103.

A printer driver with the function of converting the image data to the image description language to be processed by the external controller 102 is installed in the client PC 103. A user can issue an instruction for print via the printer driver by the various applications.

The printer driver sends the image data to the external controller 102 based on the print job from a user. After receiving a print job including image data from the client PC 103, the external controller 102 performs data analysis or rasterization process to instruct the image forming apparatus 101 to perform a print (image forming) process based on the image data.

The image forming apparatus 101 is configured to have connected apparatuses with different functions including the print apparatus 107 so that complex print process such as book binding can be performed. The image forming apparatus 101 of the present embodiment is provided with the print apparatus 107 and the finisher 109. The print apparatus 107 forms an image on a recording material fed from the feeding portion provided at a lower portion of the main body using developer (for example, toner). The print apparatus 107 forms images of yellow (Y), magenta (M), cyan (C), and black (K). A full-color image of superimposed images of respective colors is formed on the recording material. The material on which an image has been formed is conveyed from the print apparatus 107 to the finisher 109. The finisher 109 stacks the recording materials on which images have been formed.

Although, in this image processing system, the external controller 102 is connected to the image forming apparatus 101, the external controller 102 is not necessarily required. For example, the image forming apparatus 101 may be configured to obtain a print job including the image data directly from the client PC 103 via the external LAN 104. In this case, the image forming apparatus 101 performs the data analysis and the rasterization process instead of the external controller 102. Namly, the image forming apparatus 101 and the external controller 102 may be integrally configured with each other.

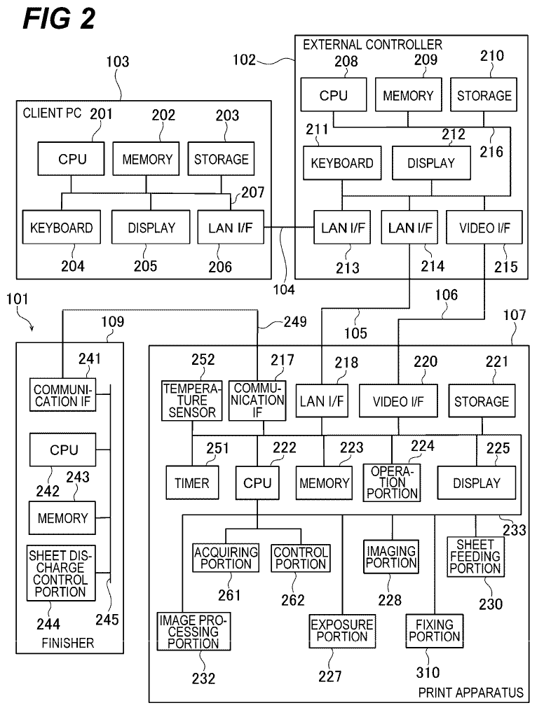

FIG. 2 is a diagram showing the system configuration for controlling the operation of the image processing system of FIG. 1. The controllers for controlling the operations of the image forming apparatus 101, the external controller 102, and the client PC 103 will be described.

The print apparatus 107 shown in FIG. 2 is provided with the communication interface (I/F) 217, the LAN I/F 218, and the video I/F 220 to communicate with other apparatuses. The print apparatus 107 is provided with the Central Processing Unit (CPU) 222, the memory 223, the storage 221, and the image processing portion 232.

The print apparatus 107 is provided with the exposure portion 227, the imaging portion 228, the fixing device 311, and the sheet feeding portion 230 to form an image. The print apparatus 107 is provided with the operation portion 224 and the display 225 as user interfaces. The print apparatus 107 is provided with the timer 251 and the temperature sensor 252 to adjust the correction value to optimally adjust the geometrical property of the images on the front surface and the back surface. Here, the geometrical property means right angularity, print position of the image with respect to the recording material, and so on. These components are connected via the system bus 233 to communicate with each other.

The communication I/F 217 is connected to the finisher 109 via the communication cable 249 to control the communication between the print apparatus 107 and the finisher 109. When the print apparatus 107 cooperatively works with the finisher 109, the information and the data are exchanged via the communication I/F 217. The LAN I/F 218 is connected to the external controller 102 via the internal LAN 105 to control the communication between the print apparatus 107 and the external controller 102. The print apparatus 107 receives print settings from the external controller 102 via the LAN I/F 218. The video I/F 220 is connected to the external controller 102 via the video cable 106 to control the communication between the print apparatus 107 and the external controller 102. The print apparatus 107 receives the image date indicative of the image to be formed from the external controller 102 via the video I/F 220.

The CPU 222 comprehensively controls the image processing and print process by executing the computer program stored in the storage 221. The memory 223 provides a working area when the CPU 222 performs various processes. When performing an image forming process, the CPU 222 controls the exposure portion 227, the imaging portion 228, the fixing device 311, and the sheet feeding portion 230.

The exposure portion 227 is provided with a photosensitive member, a charging wire for charging the photosensitive member, and a light source for exposing the photosensitive member that is charged by the charging wire to form an electrostatic latent image on the photosensitive member. The photosensitive member is for example a photosensitive belt that has a belt-shaped elastic member and a photosensitive layer formed on the belt-shaped elastic member or a photosensitive drum that has a cylinder and a photosensitive layer formed on the surface of the cylinder. Alternative of the charging wire, a charging roller can be used. The exposure portion 227 charges the surface of the photosensitive member to a uniformly negative potential by the charging wire. The exposure portion 227 emits a laser beam based on the image data from the light source. The surface of the photosensitive member uniformly charged is scanned by the laser beam. Thereby the potential in the position where the laser beam is irradiated is changed so that an electrostatic latent image is formed on the surface. Four photosensitive members for four colors of yellow (Y), magenta (M), cyan (C) and black (K) are provided. Electrostatic latent images for images of different colors are respectively formed on the four photosensitive members.

The imaging portion 228 transfers the toner image formed on the photosensitive member to the recording material. The imaging portion 228 is provided with a developing device, a transfer unit, a toner replenishing portion. The developing device forms a toner image by attaching negatively charged toner from the developing cylinder to the electrostatic latent image formed on the surface of the photosensitive member.

Four developing devices are provided corresponding to the four colors of yellow (Y), magenta (M), cyan (C) and black (K). The developing devices visualize the electrostatic latent images on the photosensitive members with the toners of corresponding colors.

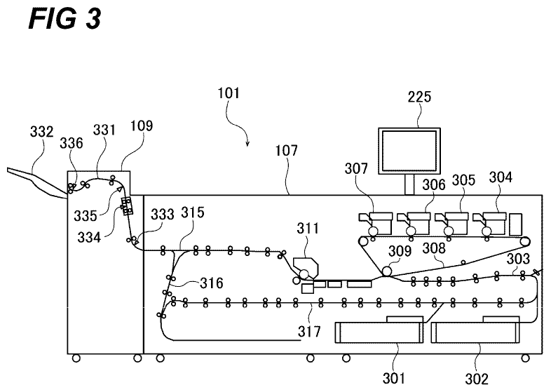

The transfer unit has the intermediate transfer belt 308 shown in FIG. 3 that will be described later and transfers the toner image from the photosensitive member to the intermediate transfer belt 308. Primary transfer rollers are provided in positions opposite the photosensitive members via the intermediate transfer belt 308. By applying positive potentials to the primary transfer rollers, the toner images on the four photosensitive members are respectively transferred in a superimposed manner on the intermediate transfer belt. Thereby a full-color toner image is formed on the intermediate transfer belt 308. The toner image formed on the intermediate transfer belt 308 is transferred onto the recording material by the secondary transfer roller 309 shown in FIG. 3 that will be described later. By being applied a positive potential, the secondary transfer roller 309 transfers the full-color toner image from the intermediate transfer belt 308 to the recording material.

The fixing device 311 fixes the transferred toner image onto the recording material. The fixing device 311 has a heater and a roller pair. The fixing device 311 melts and fixes the toner image to the recording material by applying heat and pressure to the toner image on the recording material with the heater and the roller pair. Thereby a product of the recording material on which the image is formed is produced.

The sheet feeding portion 230 is provided with conveying rollers and various sensors on a conveying path and controls the feeding operation of the recording material.

The operation portion 224 is an input device for receiving inputs for various settings and instructions of operation from a user. The operation portion 224 is exemplified as for example various input keys or a touch panel. The display 225 is an output device for displaying the setting information of the image forming apparatus 101 and processing status (status information) of print jobs.

The timer 251 counts the time. The CPU 222 acquires the present date and time based on the count value of the timer 251. The temperature sensor 252 measures the temperature in the print apparatus 107. The CPU 222 acquires the temperature in the print apparatus 107 as one of the environmental conditions based on the measurement results of the temperature sensor 252. Further, the humidity can be acquired as another one of the environmental conditions.

The finisher 109 performs the staple process of the product output from the print apparatus 107 for example. The finisher 109 is provided with the communication I/F 241, the CPU 242, the memory 243 and the sheet discharge control portion 244.

These components are connected to each other to be able to be communicated via the system bus 245. The communication I/F 241 is connected to the print apparatus 107 via the communication cable 249 to control the communication between the print apparatus 107 and the finisher 109. When the finisher 109 cooperatively works with the print apparatus 107, the information and the data are exchanged via the communication I/F 241.

The CPU 242 executes the control program stored in the memory 243 and performs various controls required for discharge of the sheet. The memory 243 stores the control program. Further, the memory 243 provides a working area when the CPU 242 performs various processes. The sheet discharge control portion 244 discharges the conveyed recording material based on the instruction from the CPU 242.

The external controller 102 is provided with the LAN I/F 213, the LAN I/F 214 and the video I/F 215 to communicate with other apparatuses. The external controller 102 is provided with the CPU 208, the memory 209 and the storage 210 to control the operation of the external controller 102. The external controller 102 is provided with the keyboard 211 and the display 212 as user interfaces. These components are connected to each other to be communicated via the system bus 216.

The LAN I/F 213 is connected to the client PC 103 via the external LAN 104 and controls the communication between the client PC 103 and the external controller 102. The external controller 102 acquires a print job from the client PC 103 via the LAN I/F 213. The LAN I/F 214 is connected to the print apparatus 107 via the internal LAN 105 and controls the communication between the print apparatus 107 and the external controller 102. The external controller 102 transmits the print setting to the print apparatus 107 via the LAN I/F 214. The video I/F 215 is connected to the print apparatus 107 via the video cable 106 and controls the communication between the print apparatus 107 and the external controller 102. The external controller 102 transmits the image data to the print apparatus 107 via the video I/F 215.

The CPU 208 comprehensively performs the processes such as the reception of the image data transmitted from the client PC 103, RIP (Raster Image Processer) process, and the transmission of the image data to the image forming apparatus 101 by executing the computer program stored in the storage 210. The memory 209 provides a working area when the CPU 208 performs various processes. The keyboard 211 is an input device for receiving inputs for various settings and instructions of operation from a user. The display 212 is an output device for displaying the information of the executed application of the external controller 102 by still images and moving images.

The client PC 103 is provided with the CPU 201, the memory 202, the storage 203, the keyboard 204, the display 205 and the LAN I/F 206. These components are connected to each other to be communicated via the system bus 207.

The CPU 201 controls the operation of the client PC 103 by executing the computer program stored in the storage 203. In the present embodiment, the CPU 201 performs the processes of the preparation of image data and the transmission of a print job. The memory 202 provides a working area when the CPU 201 performs various processes. The keyboard 204 and the display 205 are user interfaces. The keyboard 204 is an input device for receiving instructions from a user. The display 205 is an output device for displaying the information of the executed application of the client PC 103 by still images and moving images. The LAN I/F 206 is connected to the external controller 102 via the external LAN 104 and controls the communication between the client PC 103 and the external controller 102. The client PC 103 transmits a print job including the image data to the external controller 102 via the LAN I/F 206.

Further, the external controller 102 and the image forming apparatus 101 are connected to each other via the internal LAN 105 and the video cable 106. However, it is sufficient that the external controller 102 and the image forming apparatus 101 be configured to be able to receive and transmit the data necessary for a print. So, the external controller 102 and the image forming apparatus 101 may be connected by only the video cable 106, for example. Further, it is sufficient that each of the memories 202, 209, 233 and 243 holds the data and the program. These memories are realized by a volatile RAM (Random Access Memory), an non-volatile ROM (Read Only Memory), a storage, a USB (Universal Serial Bus) memory.

FIG. 3 is a diagram showing the configuration of the image forming apparatus 101.

As shown in FIG. 3, the display 225 is provided at the upper portion of the print apparatus 107. The display 225 displays print status and the setting information of the image forming apparatus 101. The recording material (product) on which an image has been formed by the print apparatus 107 is conveyed to the finisher 109 that is provided at the subsequent stage.

The print apparatus 107 is provided with the sheet decks 301 and 302, and the conveying path 303 as the sheet feeding portion 230. The sheet decks 301 and 302 can accommodate the recording materials of the types different from each other. The information of the accommodated recording materials such as basis weight and type of recording material can be detected by the apparatus. The present embodiment has the configuration in which this information can be set by a user using display 225.

The most upper sheet of the recording materials stored in the sheet deck 301 or 302 is separated and fed to the conveying path 303. The print apparatus 107 is provided with the image forming portions 304, 305, 306 and 307 for forming an image as the exposure portion 227 and the imaging portion 228. The print apparatus 107 forms a color image. For which, the image forming portions 304, 305, 306 and 307 respectively form an image (a toner image) of black (K), an image (a toner image) of cyan (C), an image (a toner image) of magenta (M), an image (a toner image) of yellow (Y).

The print apparatus 107 is provided with the intermediate transfer belt 308 on which the toner images are transferred respectively from the image forming portions 304, 305, 306 and 307 and the secondary transfer roller 309 as the imaging portion 228.

The intermediate transfer belt 308 rotates in the clockwise direction in FIG. 3 and the toner images are transferred and superimposed from the image forming portions 307, 306, 305 an 304 in this order. As a result, a full-color tone image is formed on the intermediate transfer belt 308. By the intermediate transfer belt 308 rotating, the toner image is conveyed to the secondary transfer roller 309. Synchronized with the timing with which the toner image is conveyed to the secondary transfer roller 309, the recording material is conveyed to the secondary transfer roller 309. By the secondary transfer roller 309, the toner image on the intermediate transfer belt 308 is transferred to the conveyed recording material.

The print apparatus 107 is provided with the fixing device 311. The fixing device 311 fixes the toner image onto the recording material. For which, the fixing device 311 is provided with the heating rotating member and the pressurizing rotating member. When the recording material passes through the nip portion formed by the heating rotating member and the pressurizing rotating member, heat and pressure are applied to the recording material. As a result, the toner image melts and is pressurized on the first surface of the recording material.

The recording material having passed through the fixing device 311 is guided to the conveying path 315. When duplex printing is instructed, an image is also formed on the back surface (second surface). For which, the recording material is guided to the reversing path 316. The conveying direction of the recording material conveyed to the reversing path 316 is reversed in the reversing path 316 and the recording material is further conveyed to the duplex conveying path 317. The front surface and the back surface of the recording material are reversed by switch-back conveyance in the reversing path 316 and the duplex conveying path 317. The recording material is conveyed to the conveying path 303 by the duplex conveying path 317 and an image is formed on the second surface different from the first surface when the recording material passes through the secondary transfer roller 309 and the fixing device 311.

In simplex printing or in case where images have been formed both surfaces in the duplex printing, the recording material is conveyed to the conveying path 315 and passed on to the finisher 109.

The finisher 109 can stack the recording materials passed on from the print apparatus 107. The finisher 109 is provided with the conveying path 331 and the stack tray 332 for stacking the recording materials. The conveying path 331 is provided with the conveying sensors 333, 334, 335 and 336. The recording materials conveyed from the print apparatus 107 are stacked on the stack tray 332 via the conveying path 331.

The conveying sensors 333, 334, 335 and 336 detect the passing of the recording materials conveyed in the conveying path 331. When the leading edge or the trailing edge of the recording material in the conveying direction is not detected by the conveying sensor 333, 334, 335 or 336 even when a predetermined time period has elapsed after the start of the conveyance of the recording material, the CPU 242 judges that a conveying jam (conveying malfunction) has occurred in the finisher 109. In this case, the CPU 242 informs the print apparatus 107 of the fact that a conveying jam has occurred.

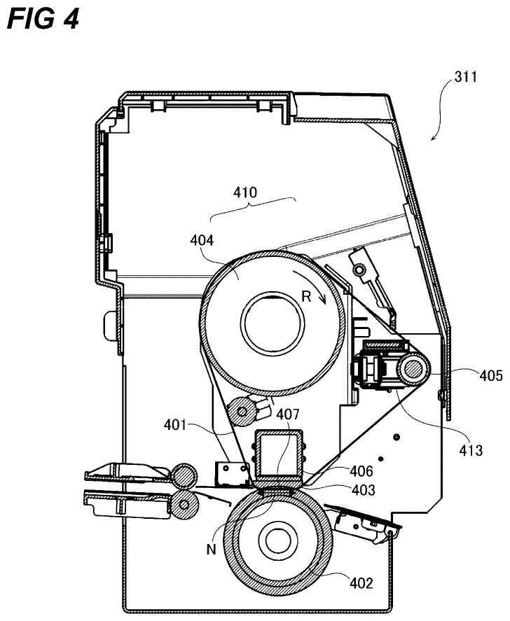

Next, the configuration of the fixing device 311 according to the present embodiment will be described in detail referring to FIG. 4. FIG. 4 is a diagram showing an enlarged cross-sectional view of the fixing device 311 according to the present embodiment.

In FIG. 4, the recording material is conveyed in the direction from the right to the left. The fixing device 311 is provided with the heating unit 410 having a heating source and the pressurizing rotating member (hereinafter referred to as pressurizing roller) 402 that forms a nip portion N together with the heating unit 410. The heating unit 410 includes fixing belt (hereinafter referred to as belt) 401 as the heating rotating member that is endless and rotatable, the pad member (hereinafter referred to as pad) 403 as the fixing member, the heating roller 404 and the steering roller 405.

Inside the heating roller 404, a halogen heater (not shown) is provided which can be heated to a predetermined temperature. The belt 401 is heated by the heating roller 404 and the temperature of the belt 401 is controlled based on the temperature detection by a thermistor to the fixing temperature corresponding to the type (basis weight) of the recording material. The thermistor may be configured to detect the surface temperature of the heating roller 404 or to detect the belt 401.

The pressurizing roller 402 is a roller in which an elastic layer is formed on the outer circumference of a shaft and a toner releasing layer on the outer circumference of the elastic layer. When the recording material on which an unfixed toner image is borne is nipped and conveyed by the pressurizing roller 402 and the belt 401 at the nip portion N, heat and pressure necessary for fixation are given to the recording material. As a result, the toner image is fixed onto the recording material.

In the fixing device, the greater the basis weight of the recording material is, the larger the amount of heat necessary of the fixation of a toner image is so that the adjusted temperature has to be set higher.

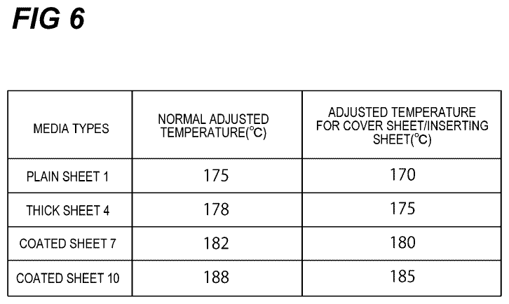

Therefore, when a fixing operation is continuously performed for the recording materials having different basis weights, the continued operation must be interrupted midway until the adjusted temperature of the fixing device is changed to the optimal adjusted temperature according to the basis weight of the recording material (normal adjusted temperature as the first adjusted temperature in FIG. 6) every time the basis weight of the recording material changes.

In this way, in a case where a fixing operation is continuously performed for the recording materials having different basis weights, when the adjusted temperature of the fixing device is changed to the optimal adjusted temperature according to each of the basis weights of the recording materials, the quality of the toner image formed on the recording material can be improved since the the adjusted temperature of the fixing device is changed to the optimal adjusted temperature in response to the basis weight of the recording material (normal adjusted temperature in FIG. 6). However, on the other hand, since the continued operation must be interrupted midway until the adjusted temperature of the fixing device is changed to the optimal adjusted temperature according to each of the basis weights of the recording materials (normal adjusted temperature in FIG. 6) every time the basis weight of the recording material changes, productivity is lowered.

In contrast, in the present embodiment, the book-prioritized temperature adjusting mode is provided. In the book-prioritized temperature adjusting mode, fixation is performed at a constant adjusted temperature (adjusted temperature corresponding to the type of the cover sheet/inserting sheet as the second adjusted temperature among the adjusted temperatures for cover sheet/inserting sheet in FIG. 6) that is lower than the normal adjusted temperature in FIG. 6 at which both the cover sheet/inserting sheet and the inner sheet can be fixed such that the inner sheet with less basis weight is not curled when the basis weight of the cover sheet/inserting sheet is greater than the basis weight of the inner sheet in a print job including the cover sheet/inserting sheet. Therefore, in the book-prioritized temperature adjusting mode, the continued fixing operation is performed without being interrupted midway and without changing the adjusted temperature between the cover sheet/inserting sheet and the inner sheet.

In this case, it is ensured that fixing malfunction does not occur by returning to the adjusted temperature for the cover sheet/inserting sheet to be targeted by using the inner sheet with less basis weight and less amount of deprived heat after the large amount of heat has been deprived by using the cover sheet/inserting sheet with greater basis weight even if the adjusted temperature for the cover sheet/inserting sheet in FIG. 6 is set to be lower than the normal adjusted temperature in FIG. 6 on condition that the cover sheet/inserting sheet does not follow the inner sheet.

A user can set the above described book-prioritized temperature adjusting mode on the setting screen displayed on the display 225 by the CPU 222.

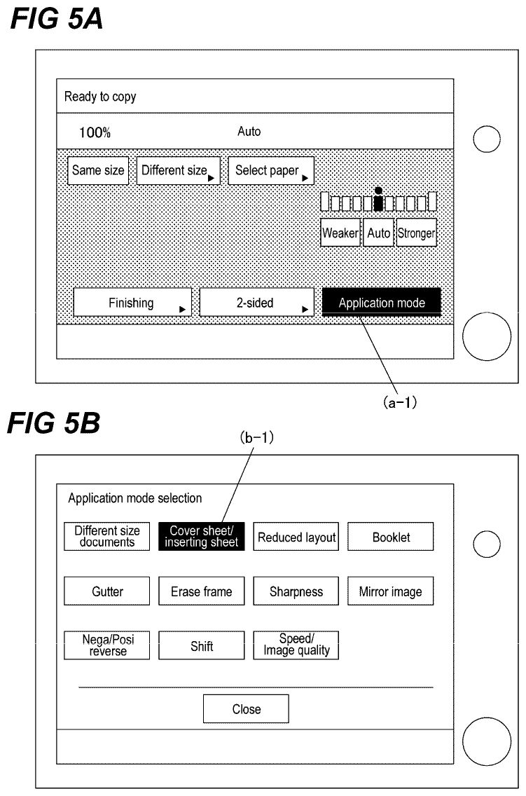

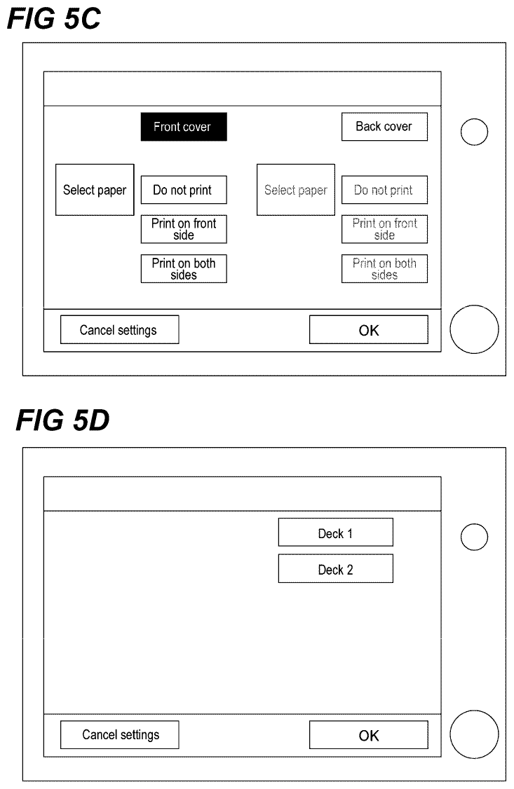

FIGS. 5A, 5B, 5C and 5D are explanatory diagrams showing a display when setting a book-prioritized temperature adjusting mode.

FIG. 5A shows the initial screen. When a user selects the software button “application mode”, the CPU 222 displays the selection screen for the application mode shown in FIG. 5B on the display 225. When a user selects the software button “cover sheet/inserting sheet”, the CPU 222 displays the setting screen shown in FIG. 5C that is for selecting a recording material of cover sheet/inserting sheet and for setting whether an image is to be printed on the cover sheet. Further, the software button of “sheet selection” is selected, the setting screen for sheet decks 301 and 302 accommodating recording materials shown in FIG. 5D is displayed on the display 225.

When outputting a print job including the cover sheet/inserting sheet, a user can input and set which position in a job the cover sheet/inserting sheet should be printed in, and can select a recording material of the cover sheet/inserting sheet/inner sheet from the operation portion 224.

The job including the cover sheet/inserting sheet often has different recording materials with different basis weights.

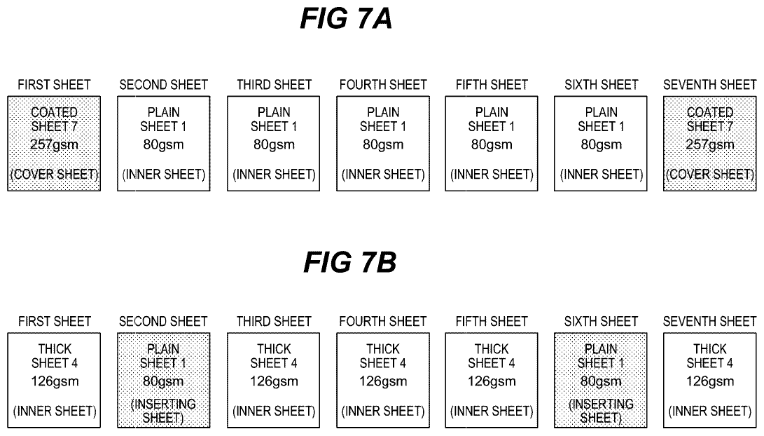

FIGS. 7A and 7B are explanatory diagrams showing a fixing order of a job with a cover sheet/inserting sheet.

FIG. 7A shows an example of a case in which the cover sheet is coated sheet 7 and the inner sheet of a text page is plain paper 1. This shows a printing procedure in a case in which the first sheet to the sixth sheet are printed as A3 size and the six sheets are subjected to the saddle stitching to make a booklet. When the adjusted temperature in this case is set by the normal temperature adjusting mode, the adjusted temperatures of the first and seventh coated sheets 7 become 182 (°C.) and the adjusted temperatures of the second to sixth plain sheets 1 become 175 (°C.) as shown in FIG. 6 FIG. 7B shows an example of a case in which the inner sheet of a text page is thick sheet 4 and the inserting sheet that is inserted in the text pages is plain paper 1.

When the adjusted temperature in this case is set by the normal temperature adjusting mode, the adjusted temperatures of the first, third, fourth, fifth and seventh thick sheets 4 become 178 (°C.) and the adjusted temperatures of the second and sixth plain sheets 1 become 175 (°C.).

In both cases shown in FIGS. 7A and 7B, when the adjusted temperature is changed, the continued fixing operation is interrupted until the temperature attains at the changed adjusted temperature, which leads to a decrease in productivity.

In contrast, even in a case of the recording materials with different basis weights in a print job including the cover sheet/inserting sheet as described above, the waiting for a change in adjusted temperature between the recording materials becomes unnecessary by selecting the above described book-prioritized temperature adjusting mode and by setting one adjusted temperature in the print job. As a result, the continuous fixing operation can be performed without decreasing productivity.

Further, a user can select a setting change such that when the user wishes to avoid a decrease in productivity due to the fact that the cover sheet should be printed or the inserting sheet is frequently inserted so that the waiting for a change in the adjusted temperature frequently occurs, the user can set the book-prioritized temperature adjusting mode, and when the user wishes to prioritize the image quality by selecting the adjusted temperature optimal for the recording material, the user can clear the book-prioritized temperature adjusting mode. The input portion for this setting change by a user can be realized by various input portions such as an input from the operation portion 224 and setting to a printer driver.

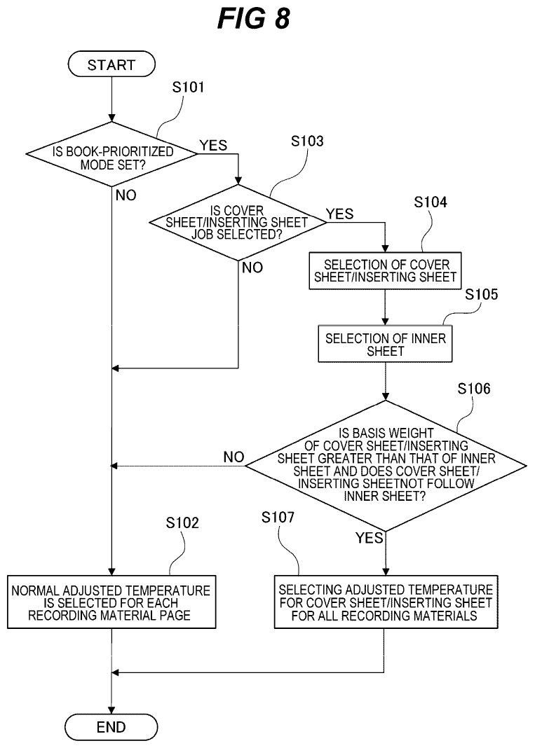

FIG. 8 is a flowchart of CPU 222 shown in FIG. 2 that decides the fixation adjusted temperature. This flowchart shows the process of book-prioritized temperature adjusting mode by which time until the completion of print can be shortened by setting the adjusted temperature of the fixing device 311 from an input print job based on the presence/absence of the book-prioritized temperature adjusting mode and the information on recording material of cover sheet/inserting sheet.

This process starts when the print apparatus 107 accepts the instruction of starting a print job from the operation portion 224 or the client PC 103.

In the step S101, the CPU 222 judges whether the book-prioritized temperature adjusting mode is selected by a user or not.

When the book-prioritized temperature adjusting mode is not set in the step S101, the process proceeds to the step S102 where the normal temperature adjusting mode shown in FIG. 6 is set corresponding to the types of the recording materials for each page.

When the book-prioritized temperature adjusting mode is set in the step S101, the process proceeds to the step S103 where the cover sheet/inserting sheet job is selected by a user or not is judged.

When the cover sheet/inserting sheet job is not selected in the step S103, the process proceeds to the step S102 where the normal temperature adjusting mode shown in FIG. 6 is set corresponding to the types of the recording materials for each page.

On the other hand, when the cover sheet/inserting sheet job is selected in the step S103, the process proceeds to the steps S104 and S105 where the recording material tused for the cover sheet/insetting sheet set by a user and the recording material used for the inner sheet are selected.

When, in the step S106, the basis weight of the recording material of the cover sheet/inserting sheet selected in the step S104 is greater than the basis weight of the inner sheet selected in the step S105 and the cover sheet/inserting sheet does not follow the inner sheet, the process proceeds to the step S107 and otherwise the process proceeds to the step S102 where the normal temperature adjusting mode shown in FIG. 6 is set corresponding to the types of the recording materials for each page.

When, in the step S106, the basis weight of the recording material of the cover sheet/inserting sheet selected in the step S104 is greater than the basis weight of the inner sheet selected in the step S105 and the cover sheet/inserting sheet does not follow the inner sheet, the adjusted temperature for the cover sheet/inserting sheet of the FIG. 6 corresponding to the recording material of the cover sheet/inserting sheet selected in the step S104 is set for all the adjusted temperatures of the recording materials in the print job in the step S107.

As described above, in the case of FIG. 7A, the basis weight of the coated sheet 7 as the cover sheet is greater than the basis weight of the plain sheet 1 as the inner sheet and the cover sheet does not follow the inner sheet. Therefore, the adjusted temperature for the cover sheet/inserting sheet can be adopted and both of the adjusted temperatures of the coated sheet 7 as the cover sheet and the plain sheet 1 as inner sheet are set to the the adjusted temperature for the cover sheet/inserting sheet of 180 (°C.) of the coated sheet 7 as the cover sheet. As a result, the book-prioritized temperature adjusting mode is adopted, which prioritizes productivity so that the continued fixing operation is performed at the constant adjusted temperature without interrupted midway and without decreasing productivity.

On the other hand, in the case of FIG. 7B, the basis weight of the plain sheet 1 as the inserting sheet is less than the basis weight of the thick sheet 4 as the inner sheet and a constant adjusted temperature for the cover sheet/inserting sheet common to the the plain sheet 1 as the inserting sheet and the thick sheet 4 as the inner sheet cannot be set. Therefore, adjusted temperatures are respectively set for recording materials: the normal adjusted temperature of 175 (°C.) is set for the plain sheet 1 as the inserting sheet and the normal adjusted temperature of 182 (°C.) is set for the thick sheet 4 as the inner sheet. In this case, the book-prioritized temperature adjusting mode is not adopted, which prioritizes productivity so that the continued fixing operation is performed at the constant adjusted temperature without interrupted midway and decreasing productivity.

In the above described embodiment, when the basis weight of the cover sheet/inserting sheet is greater than the basis weight of the inner sheet and the cover sheet/inserting sheet does not follow the inner sheet, the book-prioritized temperature adjusting mode can be adopted, in which the continued fixing operation can be performed at a common constant adjusted temperature without interrupted midway.

This is not limited to the relationship of basis weights between the cover sheet/inserting sheet and the inner sheet and can be adopted as a fixing mode in which the continued fixing operation can be performed at one common adjusted temperature without being interrupted midway likewise the above described book-prioritized temperature adjusting mode when the recording material with greater basis weight does not follow the recording material with less basis weight among the recording materials with different basis weights.

As described in the above embodiment, the productivity-prioritized mode can be set by setting the adjusted temperature of the fixing device to one common constant adjusted temperature on condition that the recording material with greater basis weight does not follow the recording material with less basis weight in a mixed job in which the recording materials with different basis weights are mixed. With this productivity-prioritized mode, the continued fixing operation can be performed without provoking a fixing malfunction even when the heating amount of the fixing device is largely deprived of by the recording material with greater basis weight and without an interruption occurring due to waiting for changing adjusted temperatures.

With the present disclosure, an image forming apparatus can be provided by which the continued fixing operation can be performed without being interrupted midway and without provoking a fixing malfunction when the continued fixing operation is performed for the recording materials with different types.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-184713, filed Oct. 21, 2024, which is hereby incorporated by reference herein in its entirety.

What is claimed is:

1. An image forming apparatus comprising:
a heating rotating member configured to supply heat to a recording material;
a pressurizing rotating member configured to pressurize the heating rotating member;
a temperature control portion configured to control a temperature of the heating rotating member;
an acquiring portion configured to acquire information regarding a basis weight of the recording material to which the toner image is fixed; and
a control portion,
wherein a toner image is fixed on the recording material by being supplied with heat and pressure by the heating rotating member and the pressurizing rotating member,
wherein one mode can be performed among multiple modes including a first mode and a second mode in a mixed job in which multiple recording materials are mixed that include a first recording material with a first basis weight and a second recording material with a second basis weight that is less than the first basis weight,
wherein when the first mode is set, the control portion performs such a control that a toner image is fixed to the recording material with the first basis weight and the recording material with the second basis weight at a common constant adjusted temperature on condition that the recording material with the first basis weight does not follow the recording material with the second basis weight, and
wherein when the second mode is set, the control portion performs such a control that a toner image is fixed to the recording material with the first basis weight at a first temperature suitable for the first basis weight and a toner image is fixed to the recording material with the second basis weight at a second temperature suitable for the second basis weight.

2. The image forming apparatus according to claim 1, further comprising:
a selection portion configured to enable a selection on whether a toner image is fixed to the recording material with the first basis weight and the recording material with the second basis weight at the common constant adjusted temperature when the first mode is set and and the recording material with the first basis weight does not follow the recording material with the second basis weight.

3. The image forming apparatus according to claim 1,
wherein the common constant adjusted temperature is set to be lower than the adjusted temperature for fixing a toner image to the recording material with the first basis weight.

4. The image forming apparatus according to claim 1,
wherein the recording material with the first basis weight is a cover sheet or an inserting sheet and the recording material with the second basis weight is an inner sheet.
